(19) United States
(12) Patent Application Publication
(10) Pub. No.: US 2024/0253124 A1
(43) Pub. Date: Aug. 1, 2024

(54) THERMAL-ANALYSIS-BASED OUTPUT STABILIZATION METHOD AND SYSTEM FOR IMPROVING 3D PRINTING OUTPUT RELIABILITY

(71) Applicant: Korea Electronics Technology Institute, Seongnam-si (KR)

(72) Inventors: Jae Ho SHIN, Hanam-si (KR); Hwa Seon SHIN, Yongin-si (KR); Hye In LEE, Anyang-si (KR); Sung Hwan CHUN, Seoul (KR); Sung Hun PARK, Seoul (KR)

(73) Assignee: Korea Electronics Technology Institute, Seongnam-si (KR)

(21) Appl. No.: 18/565,816

(22) PCT Filed: May 25, 2022
(86) PCT No.: PCT/KR2022/007391

§ 371 Date: Nov. 30, 2023

(30) Foreign Application Priority Data
May 31, 2021 (KR) 10-2021-0069906

(51) Int. Cl. B22F 10/366; B22F 10/80; B33Y 50/02; G01N 25/72

(52) U.S. Cl. CPC B22F 10/366; B22F 10/80; G01N 25/72; B33Y 50/02

(57) ABSTRACT

A thermal-analysis-based output stabilization method and system for improving 3D printing output reliability are provided. The thermal-analysis-based output stabilization method according to an embodiment of the present invention comprises steps in which: an output stabilization system performs first stacking thermal analysis on a plurality of residual heat quantity review specimens for which a process range corresponding to normal output quality is set; the output stabilization system performs second stacking thermal analysis on an actual stacked product on the basis of the first stacking thermal analysis result in the same manner as the first stacking thermal analysis method; and the output stabilization system performs stability review on the stacking result of the stacked product on the basis of the second stacking thermal analysis result.

### TECHNICAL FIELD

The disclosure relates to a thermal-analysis-based output stabilization method and system for improving 3D printing output reliability, and more particularly, a method and a system which design a specimen for measuring output stability of 3D printing and performs thermal analysis regarding a stacking process of the specimen, and extends a result therefrom to thermal-analysis-based stability examination of a real output, thereby stabilizing output.

### BACKGROUND ART

In general, when metal-based 3D printing output is performed, beads of various shapes may appear according to a change of a process parameter. FIG. 1 is a view illustrating a result of an analysis experiment for a 1D bead cross section of a metallic material which has process parameters of laser power and a scan speed, and FIG. 2 is a view illustrating a bead shape according to a process parameter.

Referring to FIGS. 1 and 2, as laser power increases, heat input per unit area increases and hence a bead size increases, and as a scan speed is faster, heat input per unit area is reduced and hence a bead size is reduced.

Accordingly, when metal-based 3D printing output is performed, there is a need to determine a hatching distance and a layering thickness based on an optimal bead shape condition.

FIG. 3 is a view illustrating a process artifact caused by overheating, and FIG. 4 is a view illustrating a process artifact caused by supercooling. Referring to FIGS. 3 and 4, when metal-based 3D printing output is performed, a process artifact may occur in a microscopic region due to overheating caused by excessive laser power and/or a relatively slow scan speed, or supercooling caused by low laser power and/or a relatively fast scan speed.

### DISCLOSURE

### Technical Problem

The disclosure has been developed in order to address the above-discussed deficiencies of the prior art, and an object of the disclosure is to provide a thermal-analysis-based output stabilization method and system for improving 3D printing output reliability, which ensures output stability based on stacking thermal analysis of an additive manufacturing product by introducing a residual heat quantity examination specimen at a step of setting a process range for normally processing without causing a process artifact, conducting a process range setting experiment, and examining structural characteristics regarding heat input and output tendencies based on the result of the experiment.

### Technical Solution

According to an embodiment of the disclosure to achieve the above-described object, a thermal-analysis-based output stabilization method may include: a step of performing, by an output stabilization system, a first stacking thermal analysis with respect to a plurality of residual heat quantity examination specimens in which a process range corresponding to normal output quality is set; a step of performing, by the output stabilization system, a second stacking thermal analysis with respect to a real additive manufacturing product in a same method as the first stacking thermal analysis method, based on the result of the first stacking thermal analysis; and a step of examining, by the output stabilization system, stability with respect to a stacking result of the additive manufacturing product, based on the result of the second stacking thermal analysis result.

In addition, the plurality of residual heat quantity examination specimens may be arranged along a plurality of columns and a plurality of rows, and may be formed to have different contact cross-sectional areas along the plurality of columns, so that a process range is set by a structural heat dissipation characteristic according to a shape.

According to an embodiment, the thermal-analysis-based output stabilization method may further include a step of conducting, by the output stabilization system, an experiment for setting the process range corresponding to the normal output quality according to a laser output power and a scan speed by using the plurality of residual heat quantity examination specimens before performing the first stacking thermal analysis.

The step of conducting the experiment may include conducting the experiment by controlling a laser output power and a scan speed in order to determine a moving tendency of a process window on the assumption of an overheating situation in a stacking process of a real additive manufacturing product.

The step of conducting the experiment may include measuring surface densities of output results of the plurality of residual heat quantity examination specimens, and setting the process range corresponding to the normal output quality.

Each of the plurality of residual heat quantity examination specimens may include: a hexahedral body disposed on an upper portion; and a base plate disposed on a lower portion of each of the bodies and having a circular cross section, the bodies may be formed to have a same size and a same shape from a 1^{st} column to an N-th column, and the base plates may be formed to have their cross-sectional diameters gradually decrease from uppermost sides connected with the bodies toward lower sides along a height direction, and cross-sectional diameters of lowermost sides of the base plates may gradually decrease from the 1^{st} column to the N-th column, so that a process range is set by a structural heat dissipation characteristic according to shapes from the 1^{st} column to the N-th column.

Wen the plurality of residual heat quantity examination specimens are arranged from the 1^{st} column to the 7^{th} column, the base plates may be formed such that a cross-sectional area of a lowermost end of the base plate disposed in the 1^{st} column is 80% of a cross-sectional area of the body, and ratios of cross-sectional areas of lowermost ends of the base plates arranged from the 2^{nd} column to the 7^{th} column to cross-sectional areas of the bodies are gradually reduced by 10% from the cross section ratio of the lowermost end of the base plate disposed in the 1^{st} column, and eventually, the cross-sectional area of the lowermost end of the base plate disposed in the 7^{th} column is 20% of the cross-sectional area of the body.

In addition, at the step of conducting the experiment, when the plurality of residual heat quantity examination specimens are arranged from an A row to a G row, a scan speed may be set to gradually increase from the A row to the G row, and, when a scan speed of the A row is 0.7 m/s, a scan speed to the G row may gradually increase by 0.1 m/s in each row, and eventually, a scan speed in the G row may reach 1.3 m/s.

The step of performing the first stacking thermal analysis may include quantitatively predicting overheating and supercooling aspects in a stacking process by performing a thermal analysis with respect to a virtual area under a same condition as an energy density of a real output situation, and the step of examining the stability may include examining stability with respect to a stacking result of the additive manufacturing product by comparing the result of the first stacking thermal analysis and the result of the second stacking thermal analysis which reflect the structural heat dissipation characteristic.

According to another embodiment of the disclosure, a thermal-analysis-based output stabilization system may include: a storage unit configured to store data regarding a process range corresponding to normal output quality, which is pre-set for a plurality of residual heat quantity examination specimens; and a processor configured to perform a first stacking thermal analysis with respect to the plurality of residual heat quantity examination specimens in which the process range corresponding to the normal output quality is set, by using the stored data, to perform a second stacking thermal analysis with respect to a real additive manufacturing product in a same method as the first stacking thermal analysis method, based on the result of the first stacking thermal analysis, and to examine stability with respect to a stacking result of the additive manufacturing product, based on the result of the second stacking thermal analysis result.

According to still another embodiment of the disclosure, a thermal-analysis-based output stabilization method may include: a step of performing, by an output stabilization system, a second stacking thermal analysis with respect to a real additive manufacturing product in a same method as a first stacking thermal analysis method, based on a result of the first stacking thermal analysis which is obtained by performing the first stacking thermal analysis with respect to a plurality of residual heat quantity examination specimens in which a process range corresponding to normal output quality is set; and a step of examining, by the output stabilization system, stability with respect to a stacking result of the additive manufacturing product, based on the result of the second stacking thermal analysis result.

According to yet another embodiment, a thermal-analysis-based output stabilization method may include: a step of conducting, by an output stabilization system, an experiment for setting a process range corresponding to normal output quality according to a laser output power and a scan speed by using a plurality of residual heat quantity examination specimens; a step of performing, by the output stabilization system, a first stacking thermal analysis with respect to the plurality of residual heat quantity examination specimens in which the process range is set; and a step of performing, by the output stabilization system, a second stacking thermal analysis with respect to a real additive manufacturing product in a same method as the first stacking thermal analysis method, based on the result of the first stacking thermal analysis.

### Advantageous Effects

According to embodiments of the disclosure as described above, output stability based on stacking thermal analysis of an additive manufacturing product may be ensured, and thus output reliability may be improved and production time and production costs may be reduced.

### DESCRIPTION OF DRAWINGS

FIG. 1 is a view illustrating an analysis experiment result of a 1D bead cross section of metal which has process parameters of laser power and a scan speed;

FIG. 2 is a view illustrating a bead shape according to process parameters;

FIG. 3 is a view illustrating a process artifact caused by overheating;

FIG. 4 is a view illustrating a process artifact caused by supercooling;

FIG. 5 is a view provided to explain a thermal-analysis-based output stabilization method according to an embodiment of the disclosure;

FIGS. 6 to 7 are views provided to explain a residual heat quantity examination specimen according to an embodiment of the disclosure;

FIGS. 8 to 9 are views provided to explain a process range setting experiment according to an embodiment of the disclosure;

FIG. 10 is a view illustrating a stacking success rate determination area according to an embodiment of the disclosure;

FIG. 11 is a view illustrating a stacking thermal analysis result of a residual heat quantity examination specimen according to an embodiment of the disclosure;

FIGS. 12A and 12B is a view illustrating a stacking thermal analysis result of an additive manufacturing product according to an embodiment of the disclosure; and

FIG. 13 is a view provided to explain a thermal analysis-based output stabilization system according to an embodiment of the disclosure.

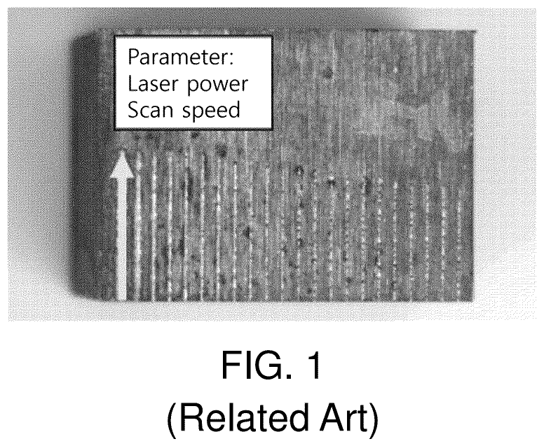

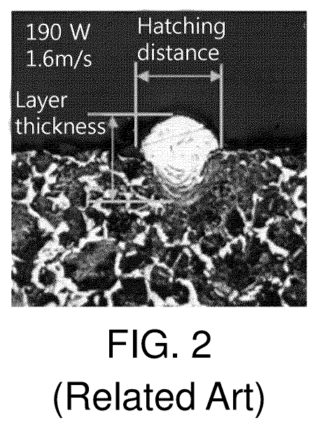

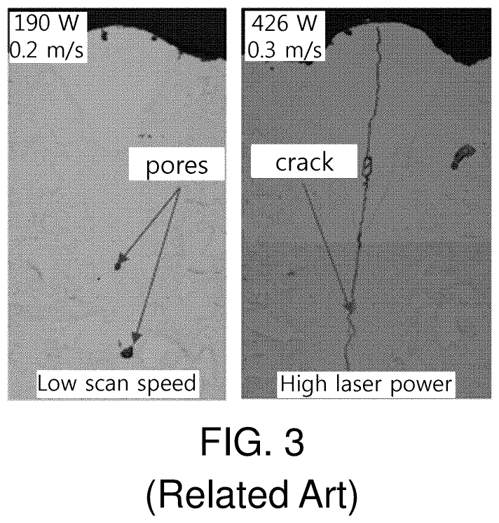

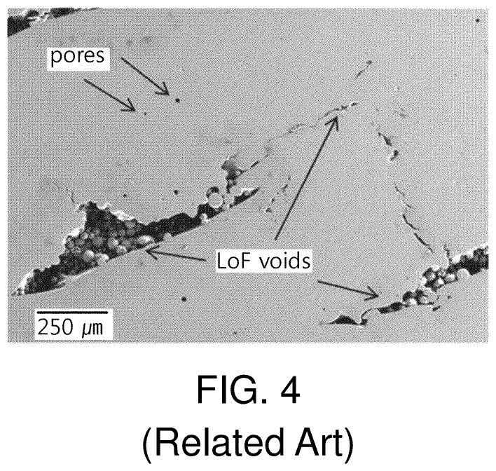

### BEST MODE

Hereinafter, the disclosure will be described in more detail with reference to the drawings.

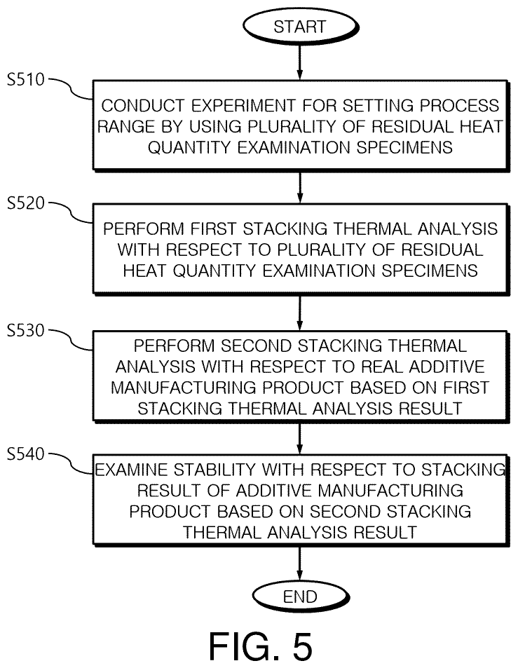

FIG. 5 is a view provided to explain a thermal-analysis-based output stabilization method according to an embodiment of the disclosure.

As described above, if heat input from lasers is less than a reference value when metal-based 3D printing output is performed, a supercooling condition may not be satisfied and melting of a material may not be achieved. On the other hand, if heat input from lasers exceeds the reference value, an overheating condition may not be satisfied and a defect may occur on a surface, thereby making it difficult to additionally stack layers.

Accordingly, the thermal-analysis-based output stabilization method according to the present embodiment is provided to ensure output stability based on stacking thermal analysis of an additive manufacturing product, by introducing a residual heat quantity examination specimen 10 at a step of setting a process range for normally processing according to laser power and a scan speed without causing a process artifact, conducting a process range setting experiment, and examining structural characteristics regarding heat input and output tendencies based on the result of the experiment.

To achieve this, the thermal-analysis-based output stabilization method may conduct an experiment for setting a process range corresponding to normal output quality according to laser output power and a scan speed by using a plurality of residual heat quantity examination specimens 10 (S510).

Specifically, the process of conducting the experiment for setting the process range may be examining density and stacking characteristics of the residual heat quantity examination specimen 10 according to energy density that is determined by a combination of laser power and a scan speed in a stacking process, and determining, as a normal operating condition, a process range corresponding to stacking characteristics within a normal range.

That is, in the process of conducting the experiment for setting the process range, the experiment may be conducted by controlling laser output power and a scan speed to determine a movement tendency of a process window on the assumption of an overheating situation in a stacking process of a real additive manufacturing product.

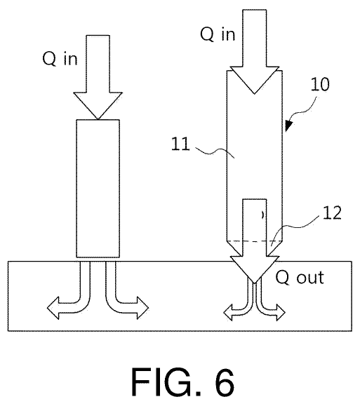

Herein, the residual heat quantity examination specimen 10 may include a body 11 disposed on an upper portion and a base plate 12 disposed on a lower portion of the body 11 as shown in the right side of FIG. 6, and a structural heat dissipation characteristic may change according to shapes of the body 11 and the base plate 12.

In a real additive manufacturing product, there may be a local difference in heat input and output tendencies according to a change of the structural heat dissipation characteristic according to a shape. Accordingly, the heat dissipation characteristic of the residual heat quantity examination specimen 10 illustrated on the right side of FIG. 6 may be quantitatively adjusted through a contact cross-sectional area of the residual heat quantity examination specimen 10, and, based on the adjusted heat dissipation characteristic, the experiment for setting the process range may be conducted.

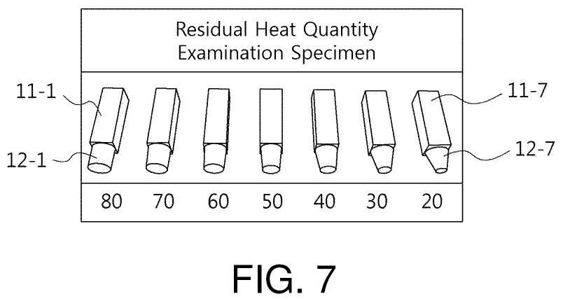

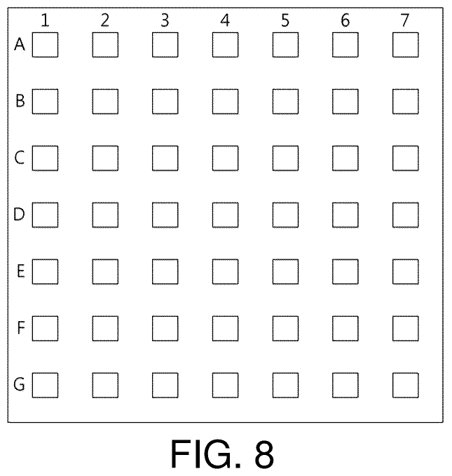

As shown in FIGS. 7 and 8, the residual heat quantity examination specimens 10 may be arranged along a plurality of columns and a plurality of rows, and may be formed to have different contact cross-sectional areas along the plurality of columns, so that a process range is set by a structural heat dissipation characteristic according to a shape.

For example, the body 11 disposed on an upper portion of each of the plurality of residual heat quantity examination specimens 10 may have a hexahedral shape, and each of the base plates 12-1 to 12-7 provided on a lower portion of each of the bodies 11-1 to 11-7 may have a circular cross section.

In this case, the bodies 11-1 to 11-7 may be formed to have the same size and the same shape from the 1^{st} column to the N-th column, and the base plates 12-1 to 12-7 may be formed to have their cross-sectional diameters gradually decrease from uppermost sides connected with the bodies 11-1 to 11-7 toward lower sides along a height direction. Herein, cross-sectional diameters of lowermost sides of the base plates 12-1 to 12-7 gradually decrease from the 1^{st} column to the N-th column, so that a process range is set by a structural heat dissipation characteristic according to shapes from the 1^{st} column to the N-th column.

Specifically, when the plurality of residual heat quantity examination specimens 10 are arranged from the 1^{st} column to the 7^{th} column, the base plates 12-1 to 12-7 may be formed such that a cross-sectional area of a lowermost end of the base plate 12-1 disposed in the 1^{st} column is 80% of a cross-sectional area of the body 11-1, and ratios of cross-sectional areas of lowermost ends of the base plates 12-2 to 12-7 arranged from the 2^{nd} column to the 7^{th} column to cross-sectional areas of the bodies 11-2 to 11-7 are gradually reduced by 10% from the cross section ratio of the lowermost end of the base plate 12-1 disposed in the 1^{st} column, and eventually, the cross-sectional area of the lowermost end of the base plate 12-7 disposed in the 7^{th} column is 20% of the cross-sectional area of the body 11-7.

In addition, when the plurality of residual heat quantity examination specimens 10 are arranged from the A row to the G row, a scan speed may be set to gradually increase from the A row to the G row. Specifically, when a scan speed of the A row is 0.7 m/s, a scan speed to the G row may gradually increase by 0.1 m/s in each row, and eventually, a scan speed in the G row may reach 1.3 m/s.

Through this, in the process of conducting the experiment for setting the process range, a user may measure surface densities of output results of the plurality of residual heat quantity examination specimens 10, and may set a process range corresponding to normal output quality.

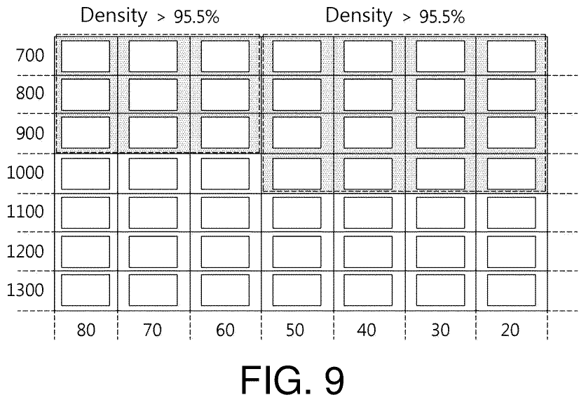

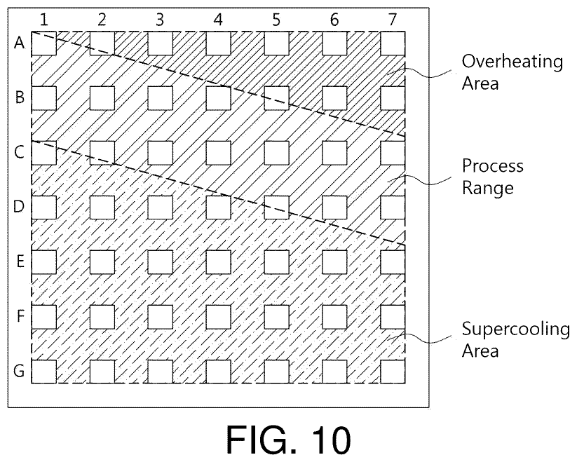

FIG. 9 is a view illustrating a result of setting a process range by measuring surface densities of output results of the residual heat quantity examination specimen 10, and FIG. 10 is a view illustrating a stacking success rate determination area when the plurality of residual heat quantity examination specimens 10 are arranged from the 1^{st} column to the N-th column and from the A row to the G row as shown in FIG. 8. In this case, in FIG. 10, an overheating area is displayed in red, a supercooling area is displayed in blue, and a process range area is displayed in green.

That is, a process should be determined within the process range displayed in green according to a heat input and output characteristic, and, when the process is shifted to the red area, an artifact may occur due to overheating, and, when the process is shifted to the blue area, an artifact may occur due to supercooling.

For example, in the case of the A1 block at row A, column 1, a stacking state of the upper portion of the residual heat quantity examination specimen 10 may be determined as being with a normal range, and, in the case of the A6 block at row A, column 6, or the B7 block at row B, column 7, a stacking state of the upper portion of the residual heat quantity examination specimen 10 may indicate an artifact that occurs due to overheating. To summarize this tendency, a process window may be variable according to a process condition and a heat dissipation path, and an output success rate may increase when a process is planned by considering a balance between energy input and output.

When the process range is set through the experiment corresponding to normal output quality, the thermal-analysis-based output stabilization method may perform a first stacking thermal analysis with respect to the plurality of residual heat quantity examination specimens 10 in which the process range is set (S520), and may perform a second stacking thermal analysis with respect to a real additive manufacturing product in the same method as the first stacking thermal analysis method, based on the result of the first stacking thermal analysis (S530).

The thermal-analysis-based output stabilization method may examine stability with respect to a stacking result of the additive manufacturing product, based on the result of the second stacking thermal analysis, and may ensure stacking stability (S540).

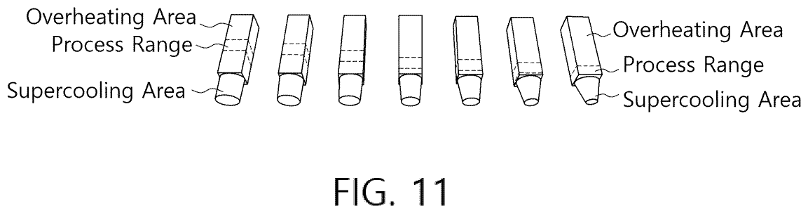

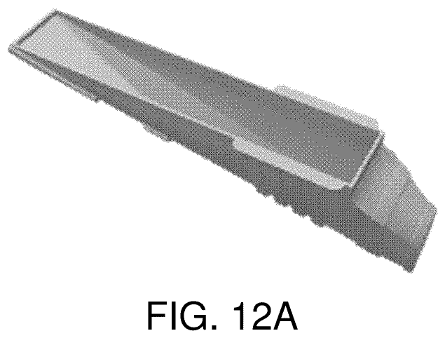

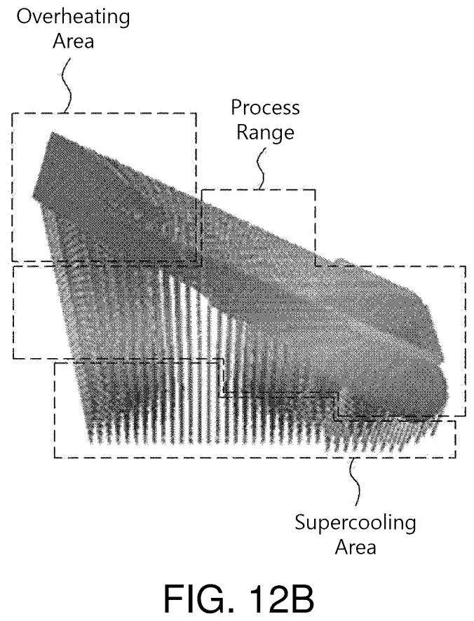

FIG. 11 is a view illustrating a stacking thermal analysis result of the residual heat quantity examination specimen 10 according to an embodiment, FIG. 12A is a view illustrating an additive manufacturing product according to an embodiment of the disclosure, and FIG. 12B is a view illustrating a stacking thermal analysis result of the additive manufacturing product according to an embodiment.

Specifically, in the process or performing the first stacking thermal analysis, overheating and supercooling aspects in a stacking process may be quantitatively predicted by performing a thermal analysis with respect to a virtual area under the same condition as an energy density in a real output situation as shown in FIG. 11.

When the first stacking thermal analysis is performed with respect to the residual heat quantity examination specimen 10 in which the process range is set, a thermal analysis result according to an experiment condition may be derived as shown in FIG. 11, and, based on the thermal analysis result, the second stacking thermal analysis may be performed with respect to a real additive manufacturing product in the same way as shown in FIGS. 12A and 12B, so that heat input and output tendencies reflecting a structural heat dissipation characteristic may be identified.

That is, in the process of examining stability, stability regarding a stacking result of the additive manufacturing product may be examined by comparing the first stacking thermal analysis result and the second stacking thermal analysis result which reflect the structural heat dissipation characteristic, and output may be stabilized by adjusting laser power and a scan speed based on the result of examining stability.

Through this, there are effects of improving output reliability and reducing production time and production costs.

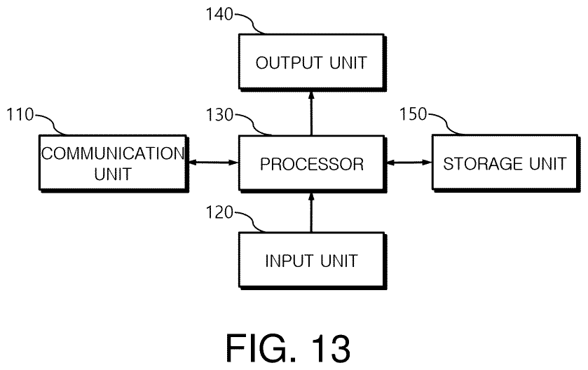

FIG. 13 is a view provided to explain a thermal-analysis-based output stabilization system according to an embodiment of the disclosure.

The thermal-analysis-based output stabilization system according to the present embodiment may execute the thermal-analysis-based output stabilization method described above with reference to FIGS. 5 to 12.

Referring to FIG. 13, the thermal-analysis-based output stabilization system may include a communication unit 110, an input unit 120, a processor 130, an output unit 140, and a storage unit 150.

The communication unit 110 is a means for communicating with external devices including a 3D printer, and connecting to a server, a cloud, etc. through a network, and may transmit/receive/upload/download data necessary for 3D printing.

The input unit 120 is a means for receiving a parameter, etc. for setting equipment of a 3D printer.

The processor 130 may perform the thermal-analysis-based output stabilization method described above with reference to FIGS. 5 to 12.

Specifically, the processor 130 may conduct an experiment for setting a process range corresponding to normal output quality according to laser output power and a scan speed by using a plurality of residual heat quantity examination specimens 10.

In addition, when a process range is set through the experiment corresponding to normal output quality, the processor 130 may perform a first stacking thermal analysis with respect to the plurality of residual heat quantity examination specimens 10 in which the process range is set, and may perform a second stacking thermal analysis with respect to a real additive manufacturing product in the same method as the first stacking thermal analysis method based on the result of the first stacking thermal analysis.

In addition, the processor 130 may examine stability with respect to a stacking result of the additive manufacturing product, based on the result of the second stacking thermal analysis.

The output unit 140 is a display that outputs information generated/processed by the processor 130 on a screen, and the storage unit 150 is a storage medium that provides a storage space necessary for normal operations of the processor 130.

The storage unit 150 may store data regarding the process range corresponding to normal output quality, which is pre-set for the plurality of residual heat quantity examination specimens 10.

The technical concept of the disclosure may be applied to a computer-readable recording medium which records a computer program for performing the functions of the apparatus and the method according to the present embodiments. In addition, the technical idea according to various embodiments of the disclosure may be implemented in the form of a computer readable code recorded on the computer-readable recording medium. The computer-readable recording medium may be any data storage device that can be read by a computer and can store data. For example, the computer-readable recording medium may be a read only memory (ROM), a random access memory (RAM), a CD-ROM, a magnetic tape, a floppy disk, an optical disk, a hard disk drive, or the like. A computer readable code or program that is stored in the computer readable recording medium may be transmitted via a network connected between computers.

In addition, while preferred embodiments of the disclosure have been illustrated and described, the disclosure is not limited to the above-described specific embodiments. Various changes can be made by a person skilled in the art without departing from the scope of the disclosure claimed in claims, and also, changed embodiments should not be understood as being separate from the technical idea or prospect of the disclosure.

1. A thermal-analysis-based output stabilization method comprising:
a step of performing, by an output stabilization system, a first stacking thermal analysis with respect to a plurality of residual heat quantity examination specimens in which a process range corresponding to normal output quality is set;
a step of performing, by the output stabilization system, a second stacking thermal analysis with respect to a real additive manufacturing product in a same method as the first stacking thermal analysis method, based on the result of the first stacking thermal analysis; and
a step of examining, by the output stabilization system, stability with respect to a stacking result of the additive manufacturing product, based on the result of the second stacking thermal analysis result.

2. The thermal-analysis-based output stabilization method of claim 1, wherein the plurality of residual heat quantity examination specimens are arranged along a plurality of columns and a plurality of rows, and are formed to have different contact cross-sectional areas along the plurality of columns, so that a process range is set by a structural heat dissipation characteristic according to a shape.

3. The thermal-analysis-based output stabilization method of claim 2, further comprising a step of conducting, by the output stabilization system, an experiment for setting the process range corresponding to the normal output quality according to a laser output power and a scan speed by using the plurality of residual heat quantity examination specimens before performing the first stacking thermal analysis.

4. The thermal-analysis-based output stabilization method of claim 2, wherein the step of conducting the experiment comprises conducting the experiment by controlling a laser output power and a scan speed in order to determine a moving tendency of a process window on the assumption of an overheating situation in a stacking process of a real additive manufacturing product.

5. The thermal-analysis-based output stabilization method of claim 4, wherein the step of conducting the experiment comprises measuring surface densities of output results of the plurality of residual heat quantity examination specimens, and setting the process range corresponding to the normal output quality.

6. The thermal-analysis-based output stabilization method of claim 2, wherein each of the plurality of residual heat quantity examination specimens comprises: a hexahedral body disposed on an upper portion; and a base plate disposed on a lower portion of each of the bodies and having a circular cross section,
wherein the bodies are formed to have a same size and a same shape from a 1^{st} column to an N-th column, and
wherein the base plates are formed to have their cross-sectional diameters gradually decrease from uppermost sides connected with the bodies toward lower sides along a height direction, and cross-sectional diameters of lowermost sides of the base plates gradually decrease from the 1^{st} column to the N-th column, so that a process range is set by a structural heat dissipation characteristic according to shapes from the 1^{st} column to the N-th column.

7. The thermal-analysis-based output stabilization method of claim 6, wherein, when the plurality of residual heat quantity examination specimens are arranged from the 1^{st} column to the 7^{th} column, the base plates are formed such that a cross-sectional area of a lowermost end of the base plate disposed in the 1^{st} column is 80% of a cross-sectional area of the body, and ratios of cross-sectional areas of lowermost ends of the base plates arranged from the 2^{nd} column to the 7^{th} column to cross-sectional areas of the bodies are gradually reduced by 10% from the cross section ratio of the lowermost end of the base plate disposed in the 1^{st} column, and eventually, the cross-sectional area of the lowermost end of the base plate disposed in the 7^{th} column is 20% of the cross-sectional area of the body.

8. The thermal-analysis-based output stabilization method of claim 6, wherein, at the step of conducting the experiment, when the plurality of residual heat quantity examination specimens are arranged from an A row to a G row, a scan speed is set to gradually increase from the A row to the G row, and, when a scan speed of the A row is 0.7 m/s, a scan speed to the G row gradually increases by 0.1 m/s in each row, and eventually, a scan speed in the G row reaches 1.3 m/s.

9. The thermal-analysis-based output stabilization method of claim 1, wherein the step of performing the first stacking thermal analysis comprises quantitatively predicting overheating and supercooling aspects in a stacking process by performing a thermal analysis with respect to a virtual area under a same condition as an energy density of a real output situation, and
wherein the step of examining the stability comprises examining stability with respect to a stacking result of the additive manufacturing product by comparing the result of the first stacking thermal analysis and the result of the second stacking thermal analysis which reflect the structural heat dissipation characteristic.

10. A thermal-analysis-based output stabilization system comprising:
a storage unit configured to store data regarding a process range corresponding to normal output quality, which is pre-set for a plurality of residual heat quantity examination specimens; and
a processor configured to perform a first stacking thermal analysis with respect to the plurality of residual heat quantity examination specimens in which the process range corresponding to the normal output quality is set, by using the stored data, to perform a second stacking thermal analysis with respect to a real additive manufacturing product in a same method as the first stacking thermal analysis method, based on the result of the first stacking thermal analysis, and to examine stability with respect to a stacking result of the additive manufacturing product, based on the result of the second stacking thermal analysis result.

11. A thermal-analysis-based output stabilization method comprising:
a step of performing, by an output stabilization system, a second stacking thermal analysis with respect to a real additive manufacturing product in a same method as a first stacking thermal analysis method, based on a result of the first stacking thermal analysis which is obtained by performing the first stacking thermal analysis with respect to a plurality of residual heat quantity examination specimens in which a process range corresponding to normal output quality is set; and
a step of examining, by the output stabilization system, stability with respect to a stacking result of the additive manufacturing product, based on the result of the second stacking thermal analysis result.

12. A thermal-analysis-based output stabilization method comprising:
a step of conducting, by an output stabilization system, an experiment for setting a process range corresponding to normal output quality according to a laser output power and a scan speed by using a plurality of residual heat quantity examination specimens;
a step of performing, by the output stabilization system, a first stacking thermal analysis with respect to the plurality of residual heat quantity examination specimens in which the process range is set;
a step of performing, by the output stabilization system, a second stacking thermal analysis with respect to a real additive manufacturing product in a same method as the first stacking thermal analysis method, based on the result of the first stacking thermal analysis.
